(19) United States
(12) Patent Application Publication
(10) Pub. No.: US 2003/0005335 A1
(43) Pub. Date: Jan. 2, 2003

(54) Protecting secured codes and circuits in an integrated circuit

(76) Inventor: Hidekazu Watanabe, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/894,473

(22) Filed: Jun. 28, 2001

(51) Int. Cl. H04L 9/32

(52) U.S. Cl. 713/202

(57) ABSTRACT

A security access system for an integrated circuit (IC) is disclosed. The system includes an access code generator and a security portal. The access code generator generates a key code that allows access to secured portions of the IC through a debug module in the IC. The security portal receives the key code from the access code generator, and allows access to the debug module if the key code matches a pre-stored code in the security portal.

### BACKGROUND

The present invention relates to an integrated circuit, and more particularly, to protecting secured codes and circuits in such an integrated circuit.

It is often necessary in areas of electronic data processing to protect secret information or circuit from unauthorized access. However, in designing integrated circuits (IC), protection of these secret information or circuit may not be a priority task. This is because the information, the circuit, and the bus that carries the information are all internal to a chip or a board. Access to memories or other peripherals within the chip would normally go through a security apparatus in the chip/board.

If the IC includes a central processing unit (CPU), a digital signal processor (DSP), or other microprocessors, the IC may provide a debug function on these processors to develop software. Thus, the debug function provides access to the entire peripherals or memories. Accordingly, the debug function on the processor may provide unauthorized “back-door” access to the secret information or circuit.

### SUMMARY

In one aspect, a security access system for an integrated circuit (IC) is disclosed. The system includes an access code generator and a security portal. The access code generator generates a key code that allows access to secured portions of the IC through a debug module in the IC. The security portal receives the key code from the access code generator, and allows access to the debug module if the key code matches a pre-stored code in the security portal.

In another aspect, an integrated circuit (IC) system is disclosed. The IC system includes a debugging tool, a processor, a plurality of peripheral device, a debug module, an access code generator, and a security portal. The peripheral devices may include secured portions, which may comprise secret codes or circuits. The debug module is coupled to the processor, and is arranged to receive commands from the debugging tool and to send data according to the commands. The access code generator generates a key code. The security portal is disposed between the debug module and the debugging tool. The security portal allows the commands from the debugging tool to pass to the debug module only when the key code from the access code generator matches an internally stored code in the security portal, such that the security portal operates to provide debugging tool with authorized access to the secured portions.

In a further aspect, a method for accessing secured portions of an integrated circuit (IC) through a debug module is disclosed. The method includes receiving a key code, determining if the received key code is correct, and enabling access to the debug module if a match is made.

### BRIEF DESCRIPTION OF THE DRAWINGS

FIG. 1 shows a typical layout of a conventional integrated circuit including at least a central processing unit (CPU) and a debug module.

FIG. 2 is a more detailed diagram of a debug module and a debugger.

FIG. 3 shows a security portal disposed between the debugger and the debug module in accordance with an embodiment of the present invention.

FIG. 4 shows one implementation of the security portal design shown in FIG. 3.

FIG. 5 shows an alternative implementation of the security portal design shown in FIG. 3.

FIG. 6 illustrates a timing diagram of a security access process.

FIG. 7 is a flowchart of the security access process according to an embodiment of the present invention.

### DETAILED DESCRIPTION

In recognition of the above-stated problem with the prior design of the integrated circuit (IC), the present invention describes embodiments for providing a security portal for debugging tools to enable only authorized access to the debug module in the IC. Consequently for purposes of illustration and not for purposes of limitation, the exemplary embodiments of the invention are described in a manner consistent with such use, though clearly the invention is not so limited.

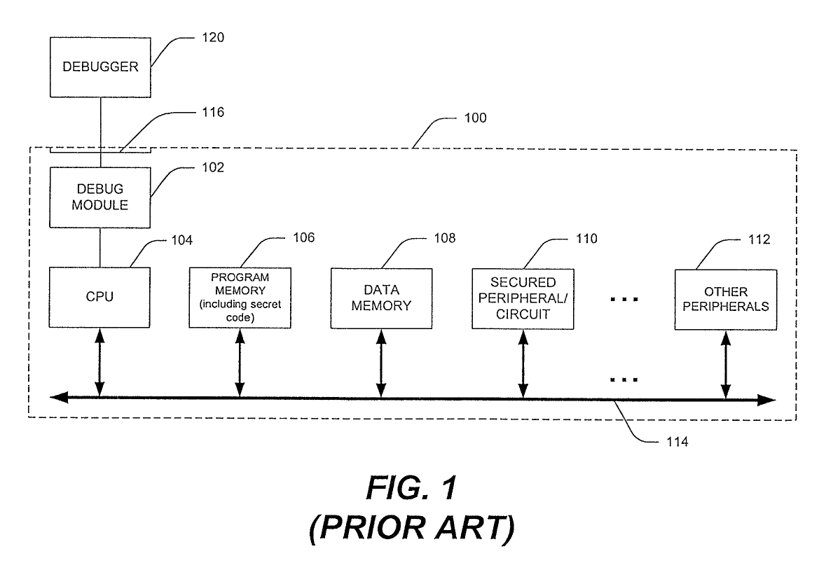

FIG. 1 shows a typical layout of a conventional integrated circuit 100 including at least a central processing unit (CPU) 104 and a debug module 102. In some cases, the debug module 102 may reside within the CPU 104. The circuit 100 may also include a program memory 106, which may include secret codes. The circuit 100 may further include a data memory 108, a secured peripheral device 110, and other peripherals 112. The devices and memories 104-112 may be connected through a bus 114. The debug module 102 provides the debugging tool 120 with access to the CPU 104 through a debug port 116 in the IC 100.

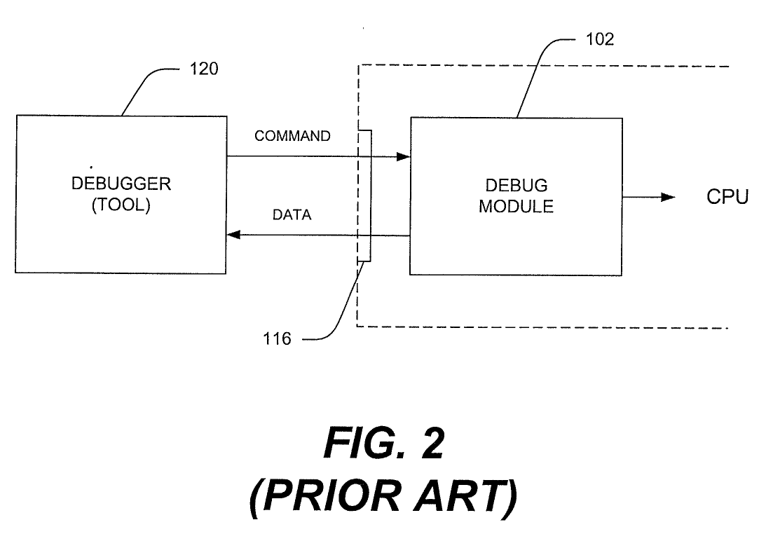

A more detailed diagram of the debug module 102 and the debugger 120 is shown in FIG. 2. The diagram also illustrates information exchange between the debug module 102 and the debugger 120 through the debug port 116. In the illustrated example, the debugger 120 sends a command to access memory or peripheral to the debug module 102, and the module 102 responds with data.

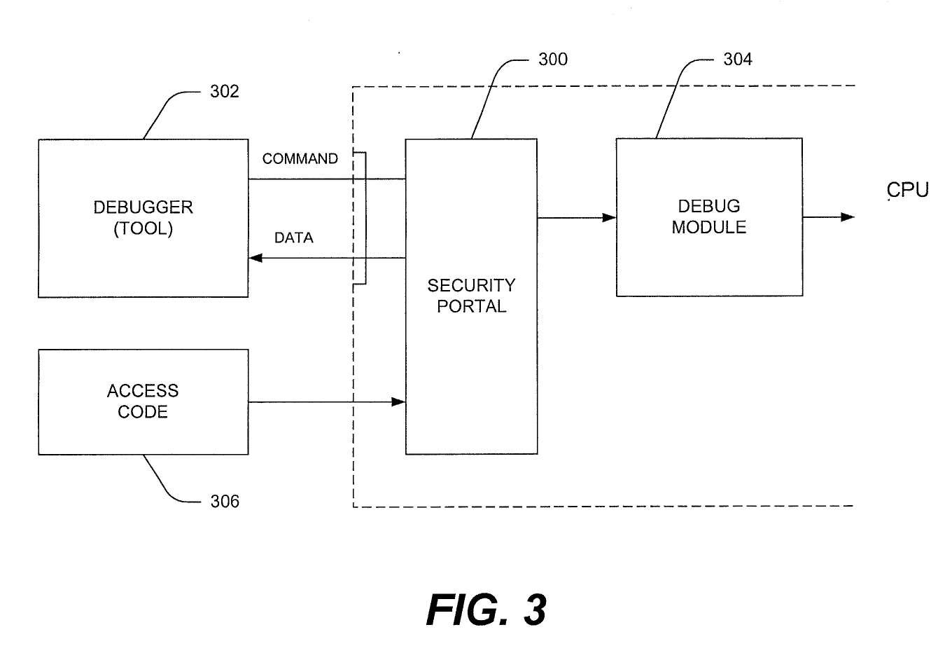

FIG. 3 shows a security portal 300 disposed between the debugger 302 and the debug module 304 in accordance with an embodiment of the present invention. The security portal 300 is arranged in a configuration that allows access to the debug module 304 only when an access code 306 that matches the pre-stored code is received at the portal 300. Thus, this design prevents unauthorized access to the debug module 304, and subsequently, to the secret code or circuit in the peripheral devices.

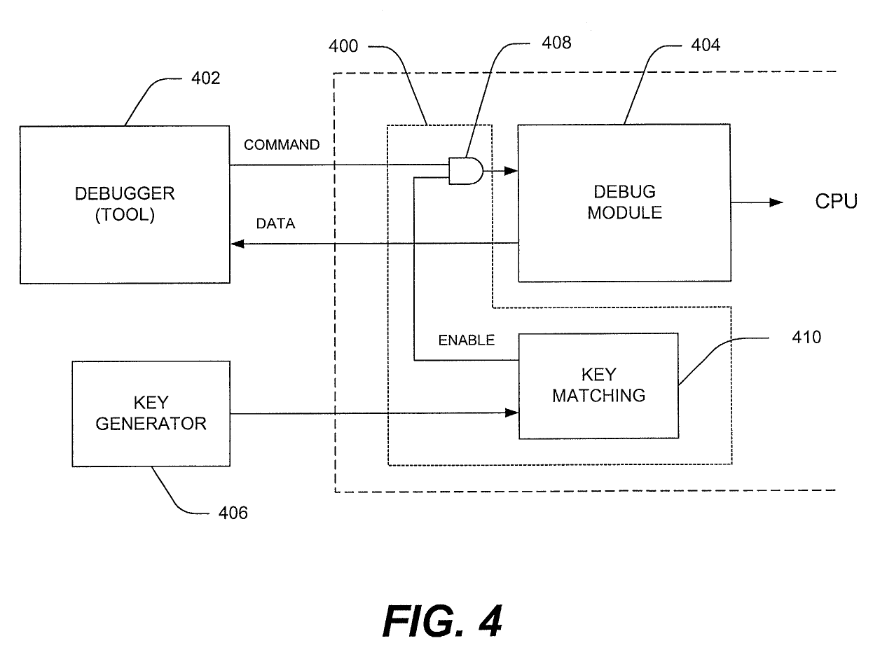

One implementation of the security portal design 400 (described in conjunction with FIG. 3) is shown in FIG. 4. In the illustrated embodiment, the security portal 400 includes an AND gate 408 and a key matching circuit 410. Moreover, the access code circuit 306 (see FIG. 3) is implemented with a key generator circuit 406. In one embodiment, the key matching circuit 410 may be implemented with a comparator, while the key generator circuit 406 may be implemented with shift registers and/or counters.

When the debugger 402 sends a command to the debug module 404, the AND gate 408 in the security portal 400 intercepts the command and does not release the command until an enable signal is received from the key matching circuit 410. While the security portal 400 is in a reset mode, the enable signal stays de-asserted, at logic low level. This keeps the output of the AND gate 408 also de-asserted to prevent the debugger commands from reaching the debug module 404, and thus, prevent the debugger 402 from obtaining unauthorized access to the secret code or circuit. When the key generator 406 supplies a key that matches a pre-stored internal key in the key matching circuit 410, the key matching circuit 410 generates the enable signal. For example, if the pre-stored internal key code is set to ‘01011010’, the key matching circuit 410 generates the enable signal only when the key generator 406 supplies the same serial code ‘01011010’ to the key matching circuit 410. This enables the debug command to reach the debug module 404, and hence, the secured portions of the IC.

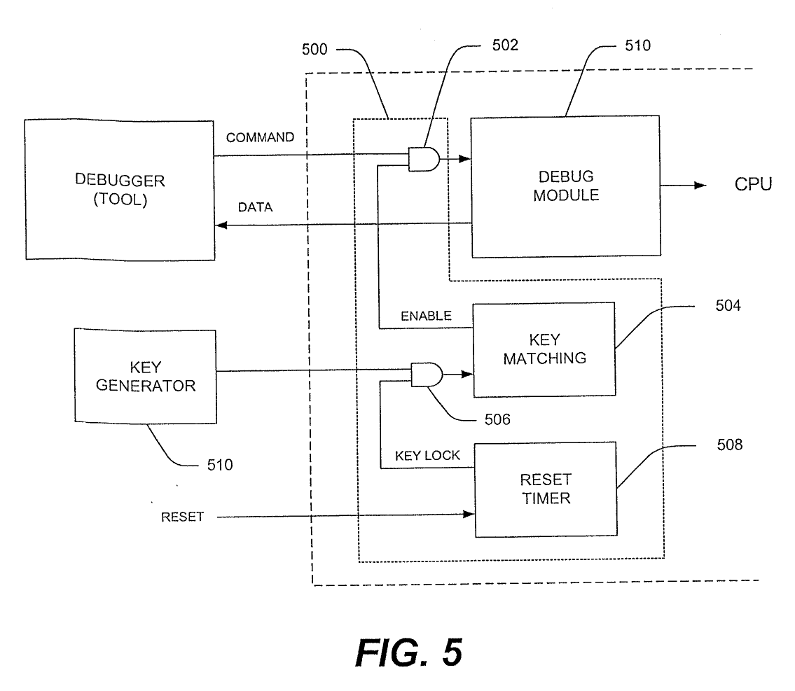

An alternative embodiment of the security portal 500 is illustrated in FIG. 5. This embodiment provides an additional layer of security by adding a reset timer 508 to the design of FIG. 4. In the illustrated embodiment, the security portal 500 includes a first AND gate 502 and a key matching circuit 504 similar to those shown in FIG. 4. However, the security portal 500 of the present embodiment further includes a second AND gate 504 and a reset timer 508. The reset timer 508 sets a window of time period within which the matching key must be supplied by the key generator 510. Thus, the reset timer 508 provides a key unlock time window starting at a system reset point. In one embodiment, the reset timer 508 may be implemented with a flip-flop.

If a correct key code is supplied to the second AND gate 506 within the time window, an enable signal is then sent to the first AND gate 502 to enable the debug command. Otherwise, if a correct key code is not supplied within that time window, the reset timer 508 prevents the key matching circuit 504 from issuing an enable signal by triggering a key lock signal to the second AND gate 506. Therefore, even if a correct key code is supplied to the second AND gate 506, if the key code arrives after the time window set up by the reset timer 508, the debug command will not be enabled. Accordingly, this embodiment prevents unauthorized access to the secured portions of the IC chip by supplying a series of key code sequences until a key code matches the pre-stored key.

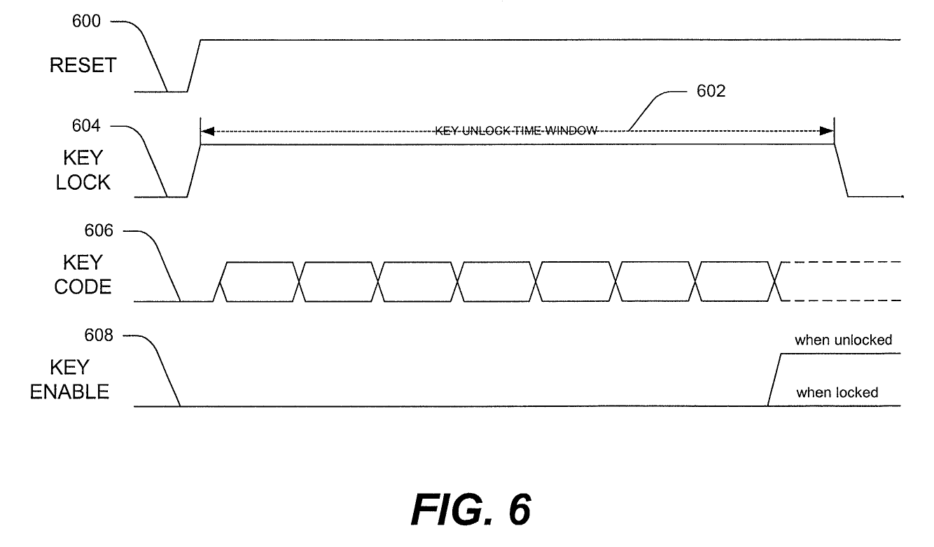

FIG. 6 illustrates the above-described process in a timing diagram. A reset signal 600 received by the reset timer 508 starts a key unlock time window 602 by triggering a key lock signal 604. If a correct key code 606 is received by the second AND gate 506 within the key unlock time window 602, an enable signal 608 is sent to the first AND gate 502. Moreover, the enable signal 608 enables the debug command to pass to the debug module 510. The length of the key unlock time window may be appropriately adjusted to allow sufficient time to enter the correct key code.

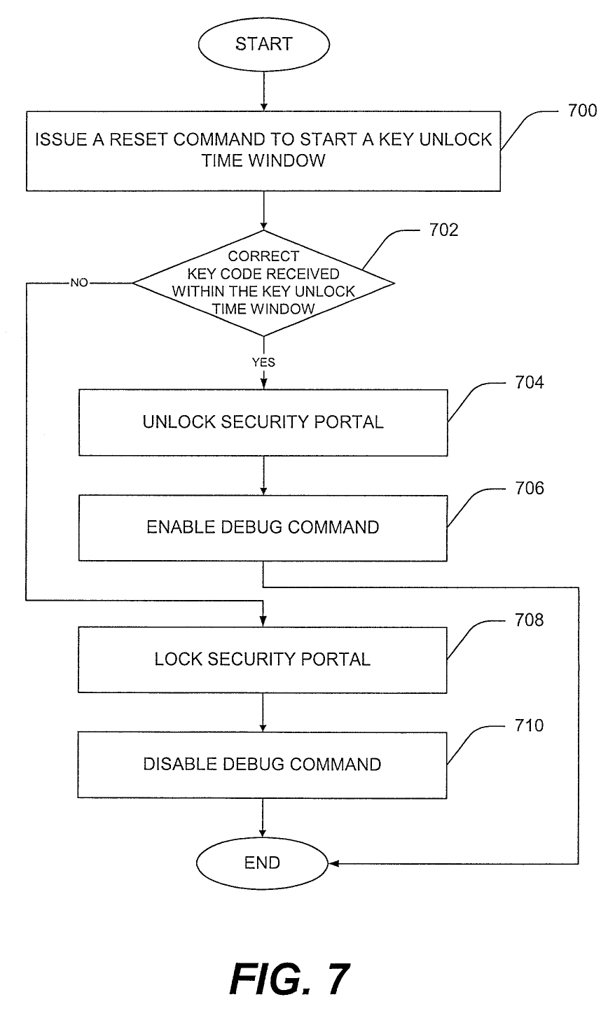

FIG. 7 is a flowchart of the security access process according to an embodiment of the present invention. The process enables only authorized access to the debug module. The process includes issuing a reset command to start a key unlock time window, at 700. If a correct key code is received (at 702), the security portal is unlocked, at 704, and the debug command is enabled, at 706. In an alternative embodiment, the correct key code must be received within the key unlock time window (at 702) to unlock the security portal and enable the debug command. Otherwise, if a correct key code is not received, the security portal is locked, at 708, and the debug command is disabled at 710.

There has been disclosed herein embodiments for providing a security portal for debugging tools to gain authorized access to the debug module in the IC. The access authorization is performed by the security portal by verifying that the correct key code is received within the key unlock time window.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the system and method may be practiced without some of these specific details. For example, the circuits in the security portal may be implemented with devices such as comparators, shift registers, counters, and/or flip-flops. In other instances, well-known structures and functions were not described in elaborate detail in order to avoid obscuring the subject matter of the present invention. Accordingly, the scope and spirit of the invention should be judged in terms of the claims which follow.

What is claimed is:

1. A security access system for an integrated circuit (IC), comprising:
an access code generator to generate a key code that allows access to secured portions of the IC through a debug module in the IC; and
a security portal arranged to receive the key code from the access code generator, and allow access to the debug module if the key code matches a pre-stored code in the security portal.

2. The system of claim 1, wherein said access code generator includes a series of registers arranged to provide the key code.

3. The system of claim 2, wherein the key code is a sequence of binary digits.

4. The system of claim 1, wherein said security portal includes
a key matching circuit to compare the key code entered by the access code generator with the pre-stored code in the security portal, where said key matching circuit generates an enable signal if the key code matches the pre-stored code.

5. The system of claim 4, wherein said key matching circuit includes a comparator.

6. The system of claim 4, further comprising:
a debug command enabling element arranged to allow access to the debug module when the enable signal is received from the key matching circuit.

7. The system of claim 6, wherein said debug command enabling element includes an AND gate.

8. The system of claim 6, further comprising:
a reset timer to provide a time window within which the key code from the access code generator is supplied to the key matching circuit, said reset timer de-asserting a key lock signal for a programmed time duration.

9. The system of claim 8, further comprising:
a key unlocking element arranged to pass the key code generated by the access code generator while the key lock signal is de-asserted.

10. The system of claim 9, wherein said key unlocking element includes an AND gate.

11. The system of claim 8, wherein said reset timer includes at least one flip-flop.

12. The system of claim 8, wherein said reset timer includes at least one register.

13. An integrated circuit (IC) system, comprising:
a debugging tool;
a processor;
a plurality of peripheral devices coupled to said processor, said plurality of peripheral devices including secured portions, which may comprise secret codes or circuits;
a debug module coupled to said processor, said debug module arranged to receive commands from the debugging tool and to send data according to said commands;
an access code generator to generate a key code; and
a security portal disposed between said debug module and said debugging tool, said security portal allows the commands from the debugging tool to pass to the debug module only when the key code from the access code generator matches an internally stored code in the security portal,
such that said security portal operates to provide debugging tool with authorized access to said secured portions.

14. The system of claim 13, further comprising:
a bus connecting said plurality of peripheral devices and the processor, such that data communication is enabled among said plurality of devices and the processor.

15. The system of claim 13, wherein said plurality of peripheral devices includes memory devices having secret codes.

16. The system of claim 13, wherein said processor is a central processing unit (CPU).

17. The system of claim 13, wherein said processor is a digital signal processor (DSP).

18. The system of claim 13, wherein security portal includes
a key matching circuit to compare the key code generated by the access code generator with the internally stored code in the security portal, where said key matching circuit generates an enable signal if the key code matches the internally stored code.

19. The system of claim 18, further comprising:
a reset timer to provide a time window within which the key code from the access code generator is supplied to the key matching circuit, said reset timer de-asserting a key lock signal for a programmed time duration.

20. The system of claim 19, further comprising:
a key unlocking element arranged to pass the key code generated by the access code generator while the key lock signal is de-asserted.

21. A method for accessing secured portions of an integrated circuit (IC) through a debug module, comprising:
receiving a key code;
determining if the received key code is correct; and
unlocking and enabling access to the debug module if a match is made.

22. The method of claim 21, wherein said determining includes matching the received key code with a pre-stored code.

23. The method of claim 21, wherein said unlocking and enabling includes passing a debug command to the debug module.

24. The method of claim 21, further comprising:
issuing a reset command to start a key unlock time window.

25. The method of claim 24, wherein said determining includes verifying that the received key code is correct, and that the key code is received within the key unlock time window.

26. The method of claim 21, further comprising:
locking and disabling access to the debug module if a match is not made.
